(19) United States
(12) Patent Application Publication
(10) Pub. No.: US 2014/0294337 A1
(43) Pub. Date: Oct. 2, 2014

(54) OPTICAL IQ MODULATOR

(71) Applicant: U2T PHOTONICS UK LIMITED, London (GB)

(72) Inventors: John Heaton, Malvern (GB); Yi Zhou, Darlington (GB)

(21) Appl. No.: 14/350,984

(22) PCT Filed: Sep. 20, 2012
(86) PCT No.: PCT/GB2012/052332

§ 371 Date: Apr. 10, 2014

(30) Foreign Application Priority Data
Oct. 10, 2011 (GB) 1117451.3
Nov. 4, 2011 (GB) 1119093.1

(51) Int. Cl. G02F 1/225

(52) U.S. Cl. CPC G02F 1/225
USPC 385/3

(57) ABSTRACT

An optical IQ modulator (10) comprising•a modulator input port (11);•a modulator output port (12);•a plurality of optical branches (13) connected in parallel therebetween;•each optical branch (13) comprising an optical interferometer (1), each optical interferometer (1) comprising•an optical splitter (2);•an optical combiner (3); and,•a plurality of optical paths (4) connected therebetween:•at least one electrode (7) arranged in close proximity to an optical path (4) for altering the phase of an optical signal passing along the path (4);•the optical splitter (2) being in being in optical communication with the modulator input port (11) and being adapted to split light received from the modulator input port (11) into the plurality of optical paths (4);•the optical combiner (3) having an optical output port (5) in optical communication with the modulator output port (12), the optical combiner (3) being adapted to combine the optical signals from the plurality of optical paths (4) at the output port (5);•at least one optical interferometer (1) comprising an optical tap (8) adapted to receive and combine the optical signals from the plurality of optical paths (4) in a different phase relation to the combination at the output port (5) of the interferometer combiner (3).

The present invention relates to an optical IQ modulator. More particularly, but not exclusively, the present invention relates to an optical IQ modulator comprising a plurality of branches, each branch including an interferometer, at least one interferometer comprising an optical combiner for combing the optical signals from different optical paths of the interferometer in a first phase relation and an optical tap for combing the optical signals in a different phase relation.

Optical IQ modulators are known. Before use the output of the IQ modulator is maximised by tuning the voltages on the electrodes of the modulator interferometers. This however is difficult to achieve in practice. It also does not guarantee that the outputs of all different branches of the modulator are all correctly and independently maximised.

The optical IQ modulator according to the invention seeks to overcome the problems of the prior art.

Accordingly, in a first aspect, the present invention provides an optical IQ modulator comprising
a modulator input port;
a modulator output port;
a plurality of optical branches connected in parallel therebetween;
each optical branch comprising an optical interferometer, each optical interferometer comprising
   an optical splitter;
   an optical combiner; and,
   a plurality of optical paths connected therebetween;
   at least on electrode arranged in close proximity to an optical path for altering the phase of an optical signal passing along the path;
   the optical splitter being in being in optical communication with the modulator input port and being adapted to split light received from the modulator input port into the plurality of optical paths;
   the optical combiner having an optical output port in optical communication with the modulator output port, the optical combiner being adapted to combine the optical signals from the plurality of optical paths at the output port;
at least one optical interferometer comprising an optical tap adapted to receive and combine the optical signals from the plurality of optical paths in a different phase relation to the combination at the output port of the interferometer combiner.

By employing such an optical tap the optical IQ modulator according to the invention can be set up for use relatively easily.

The optical IQ modulator according to the invention has one or more branches the output of which can be independently maximised.

Preferably, the optical tap is adapted such that the output from the optical tap is a minimum when the output from the output port of the optical combiner is a maximum.

The optical IQ modulator can further comprise optical signal measurement means connected to the optical tap.

The optical signal measurement means can measure the amplitude of the optical signal at the tap.

Alternatively, the optical measurement means can measure the intensity of the optical signal at the tap.

Preferably, each optical interferometer comprises an optical tap.

Preferably, the at least one optical interferometer has an electrode in close proximity to each optical path.

Preferably, each optical interferometer has an electrode in close proximity to each optical path.

The optical IQ modulator can further comprise a voltage source connected to at least one of the electrodes.

The optical IQ modulator can further comprise a coherent optical source, preferably a continuous wave laser, connected to the modulator input port.

The optical IQ modulator can further comprise a phase shifter, preferably a 90 degree phase shifter, arranged between the output port of at least one optical interferometer and the modulator output port.

Preferably, the optical IQ modulator comprises two branches, each branch comprising an optical interferometer.

Preferably, each interferometer comprises two optical paths.

The present invention will now be described by way of example only and not in any limitative sense with reference to the accompanying drawings in which

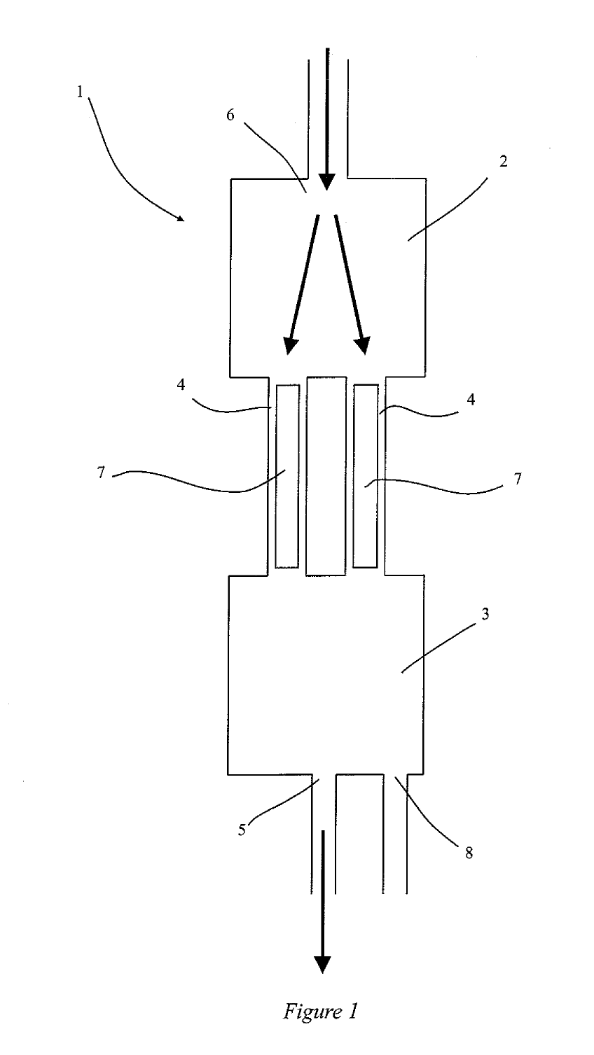

FIG. 1 shows, in schematic form, an optical interferometer of an optical IQ modulator according to the invention;

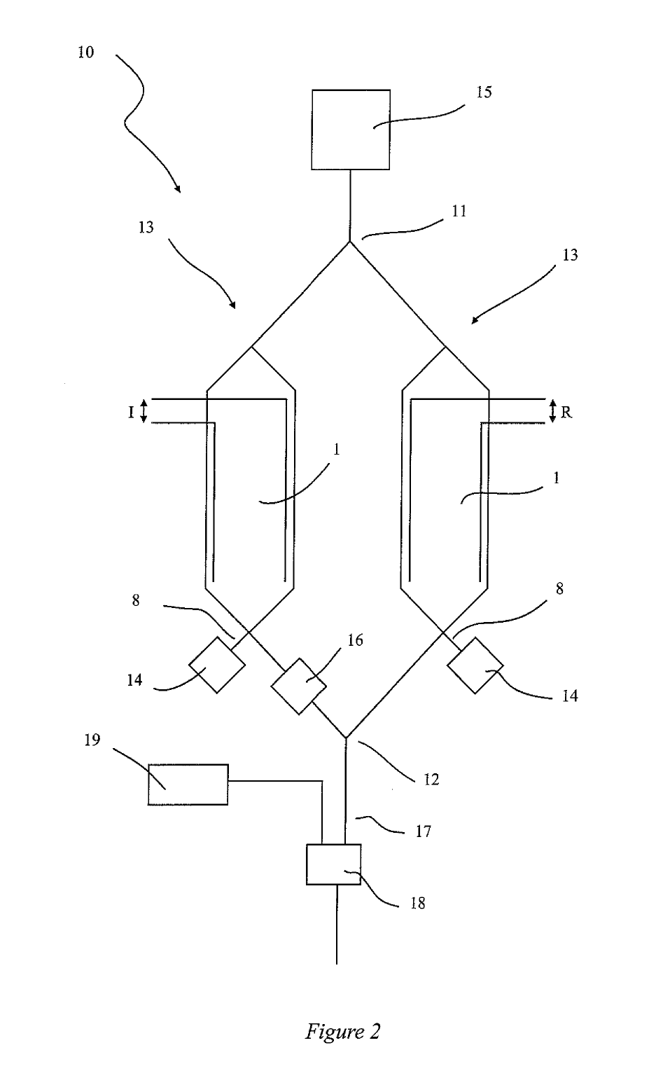

FIG. 2 shows, in schematic form, an optical IQ modulator according to the invention;

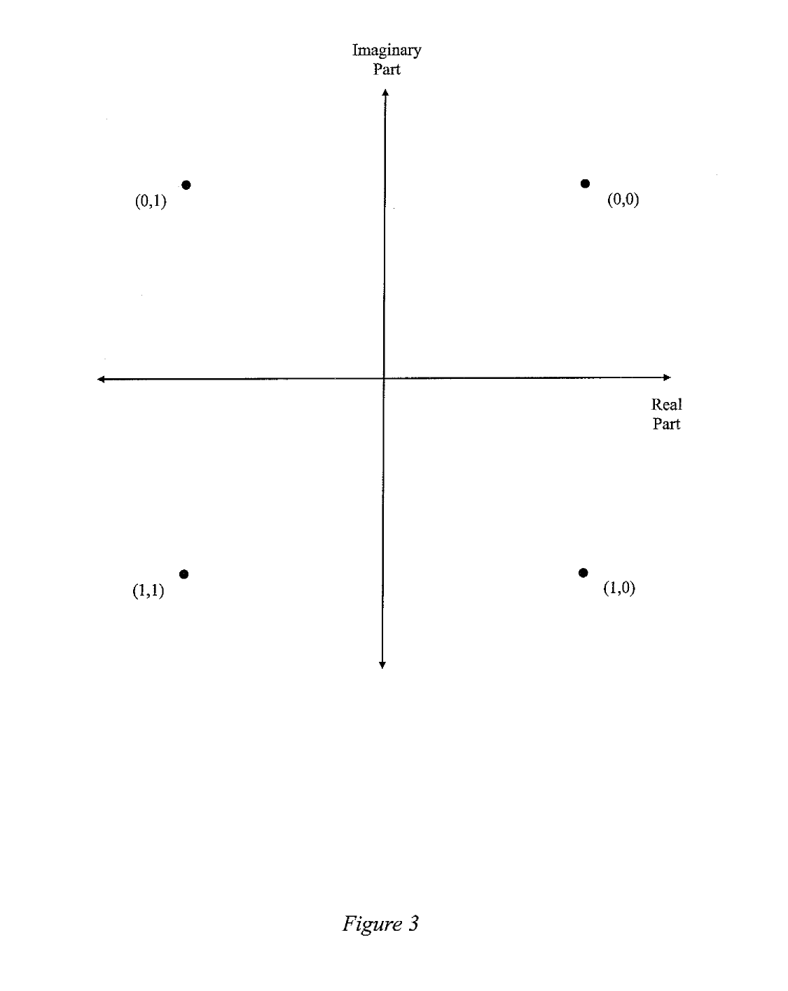

FIG. 3 shows the output of the optical IQ modulator of FIG. 2 as a function of voltage applied to the electrodes of the interferometers.

Shown in FIG. 1 is an interferometer 1 of an optical IQ modulator according to the invention. The interferometer 1 comprises an optical splitter 2, an optical combiner 3 and a plurality of optical paths 4 extending therebetween.

In use a coherent optical signal is provided to the optical splitter 2. The splitter 2 splits the optical signal into signals which travel along each of the optical paths until they reach the optical combiner 3. At the optical combiner 3 the signals from the optical paths are recombined at the output port 5 of the combiner 3.

Assuming that all of the optical paths are identical then the signals which travel along the optical paths 4 will recombine in phase at the output port 5 of the combiner 3. An optical signal presented at the input port 6 of the interferometer 1 is therefore received at the output port 5 of the combiner 3.

Arranged in close proximity to each of the optical paths 4 is an electrode 7. By applying a voltage to these electrodes 6 one can alter the refractive index of the material of the adjacent optical paths 4. If one applies different voltages to different electrodes 7 then the optical signals travelling down the different optical paths 4 become slightly out of phase. They will therefore recombine at the output 5 of the combiner 3 slightly out of phase. By applying voltages to the electrodes 7 one can therefore adjust the amplitude of the signal received at the output port 5 of the combiner 3.

The optical combiner 3 shown in FIG. 1 further comprises an optical tap 8 spaced apart from the output port 5 of the optical combiner 3. The outputs from the optical paths 4 also combine at the optical tap 8 although in a different phase relation. In this embodiment the optical tap 8 is arranged such that when the voltages on the electrodes 6 are arranged such that output from the output port 5 of the combiner 3 is a minimum the output from the optical tap 8 is a maximum.

Shown in FIG. 2 is an optical IQ modulator 10 according to the invention. The optical IQ modulator 10 comprises a modulator input port 11, a modulator output port 12 and a plurality of optical branches 13 extending therebetween. Each optical branch 13 comprises an optical interferometer 1 as shown in FIG. 1. Connected to the optical tap 8 of each interferometer 1 is an optical measurement means 14 which measures the intensity of the output signal from the optical tap 8.

Connected to the input port 11 of the optical IQ modulator 10 is a coherent optical source 15, in this case a continuous wave laser. Connected between the output port 5 of one of the interferometers 1 and the modulator output port 12 is a 90 degree phase shifter 16.

A final optical path 17 is connected between the modulator output port 12 and a reference combiner 18. Also connected to the reference combiner 18 is a reference continuous wave laser 19. The reference combiner 18 combines the output from the IQ modulator 10 with the output from the reference continuous wave laser 19.

In use the coherent optical source 15 provides an optical signal to the input port 11 of the IQ modulator 10. The signal is split and passes down each of the optical branches 13 and through the optical interferometers 1. The output from one of the interferometers passes through the 90 degree phase changer 16. The outputs from the interferometers 1 are then combined at the modulator output port 12. The combined output from the modulator output port 12 then passes along the final optical path 17 to the combiner 18 where it is combined with the reference signal from the reference continuous wave laser 19 to provide a final output.

Before the optical IQ modulator 10 can be used to transmit data the voltages on the electrodes 7 of the interferometers 1 must be set to the correct values. A voltage source (I) is connected across the electrodes 7 of the first interferometer 1. The voltage difference between the electrodes 7 is then increased until the output signal at the associated optical tap 8 is a minimum. At this voltage the output from the interferometer 1 at the combiner output port 5 is a maximum. This is then repeated with a voltage source (R) connected between the electrodes 7 of the second interferometer 1. The voltages at which these maxima occur are referred to as the ‘tuning’ voltages' for the interferometers 1 and vary between interferometers 1 due to manufacturing tolerances.

Once the voltages I and R have been correctly set then signal voltages are applied to the electrodes 7 of the interferometers by the voltage sources I, R (measured relative to the tuning voltages set earlier). Application of these voltages alters the imaginary and real components of the output of the IQ modulator 10 measured relative to the reference signal of the reference continuous wave laser 15.

Shown in FIG. 3 is the real and imaginary component of the output of the optical IQ modulator 10 relative to the reference signal. The voltages applied between the electrodes 7 of each interferometer 1 are digital voltages being either low voltage (‘O’) or high voltage (‘1’). As can be seen, with the IQ modulator 10 according to the invention one can transmit two bits of information simultaneously in the output signal from the modulator 10.

In an alternative embodiment of the invention the IQ modulator 10 has more than two optical branches 13. The modulator 10 could for example have four branches. With such a modulator 10 one could transmit four bits of information simultaneously. In other embodiments other numbers of branches 13 are possible.

In a further embodiment of the invention some but not all of the interferometers 1 have optical taps 8.

1. An optical IQ modulator comprising:
a modulator input port;
a modulator output port; and
a plurality of optical branches connected in parallel between the modulator input and output ports;
each optical branch comprising an optical interferometer, each optical interferometer comprising:
an optical splitter;
an optical combiner;
a plurality of optical paths connected between the optical splitter and combiner; and
at least one electrode arranged in close proximity to at least one of the plurality of optical paths for altering the phase of an optical signal passing along the at least one of the plurality of optical paths;
the optical splitter being in optical communication with the modulator input port and being adapted to split light received from the modulator input port into the plurality of optical paths;
the optical combiner having an optical output port in optical communication with the modulator output port, the optical combiner being adapted to combine optical signals from the plurality of optical paths at the optical output port;
at least one of the optical interferometers comprising an optical tap adapted to receive and combine the optical signals from the plurality of optical paths in a different phase relation to the combined optical signals at the output port of the optical combiner.

2. An optical IQ modulator as claimed in claim 1, wherein the optical tap is adapted such that an output from the optical tap is a minimum when an output from the output port of the optical combiner is a maximum.

3. An optical IQ modulator as claimed in claim 1, further comprising an optical signal measurement means connected to the optical tap.

4. An optical IQ modulator as claimed in claim 3, wherein the optical signal measurement means measures an amplitude of the optical signal at the optical tap.

5. An optical IQ modulator as claimed in claim 3, wherein the optical measurement means measures an intensity of the optical signal at the optical tap.

6. An optical IQ modulator as claimed in claim 1, wherein each optical interferometer comprises the optical tap.

7. An optical IQ modulator as claimed in claims 1, wherein the at least one of the optical interferometers has the at least one electrode in close proximity to each of the plurality of optical paths.

8. An optical IQ modulator as claimed in claim 7, wherein each optical interferometer has the at least one electrode in close proximity to each of the plurality of optical paths.

9. An optical IQ modulator as claimed in claim 1, further comprising a voltage source connected to the at least one electrode.

10. An optical IQ modulator as claimed in claim 1, further comprising a coherent optical source connected to the modulator input port.

11. An optical IQ modulator as claimed in claim 1, further comprising a phase shifter arranged between the output port of the optical combiner and the modulator output port.

12. An optical IQ modulator as claimed in claim 1, wherein the IQ modulator comprises two branches, each branch comprising at least one of the optical interferometers.

13. An optical IQ modulator as claimed in claim 1, wherein each optical interferometer comprises two optical paths.

14. (canceled)

15. The optical IQ modulator as claimed in claim 10, wherein the coherent optical source is a continuous wave laser.

16. The optical IQ modulator as claimed in claim 11, wherein the phase shifter is a 90 degree phase shifter.
